(19) United States
(12) Patent Application Publication
(10) Pub. No.: US 2026/0303995 A1
(43) Pub. Date: Oct. 1, 2026

(54) ELECTRONIC APPARATUS AND CONTROL METHOD

(71) Applicant: CANON KABUSHIKI KAISHA, Tokyo (JP)

(72) Inventor: YASUHITO KIGURE, Tokyo (JP)

(21) Appl. No.: 19/570,591

(22) Filed: Mar. 18, 2026

(30) Foreign Application Priority Data
Mar. 27, 2025 (JP) 2025-053748

(51) Int. Cl. H04N 25/709; H02J 1/12; H02J 105/44

(52) U.S. Cl. CPC H04N 25/709; H02J 1/12; H02J 2105/44

(57) ABSTRACT

An electronic apparatus includes a first connector, a second connector and receives power from a power supply apparatus connected to the first connector and converts a voltage supplied from the power supply apparatus via the first connector. The electronic apparatus performs control to switch, in accordance with information regarding power consumption of a power receiving apparatus which is acquired from the power receiving apparatus connected to the second connector, between a first state where a voltage supplied from the power supply apparatus is output to the power receiving apparatus via the second connector without conversion by the voltage conversion unit, and a second state where a voltage converted by the voltage conversion unit is output to the power receiving apparatus via the second connector.

### BACKGROUND

### FIELD OF THE TECHNOLOGY

The present disclosure relates to control of power supply from a power supply apparatus to a power receiving apparatus.

### DESCRIPTION OF THE RELATED ART

The Universal Serial Bus (USB) Power Delivery (PD) standard is a standard for connecting a power supply apparatus and a power receiving apparatus by connectors and a cable of the USB Type-C standard to enable supply of power of 240 W (48 V, 5 A) at maximum. USB PD is known as a power supply method for power receiving apparatuses such as a digital camera and a smartphone.

For a digital camera, as a method for eliminating the concern of battery exhaustion and enabling long-term shooting, there is a method of attaching a DC coupler to a digital camera and supplying power to the digital camera from an external power supply apparatus via the DC coupler. The DC coupler converts commercial alternating current power (to be referred to as AC power hereinafter) into a direct current voltage (to be referred to as a DC voltage hereinafter) corresponding to the specifications of the digital camera and supplies it to the digital camera. In a case of a DC coupler complying with USB PD, the DC coupler receives power from a power supply apparatus complying with USB PD, converts it into a direct current voltage (to be referred to as a DC voltage hereinafter) corresponding to the specifications of a digital camera, and supplies it to the digital camera. Therefore, by using a DC coupler complying with USB PD, even a digital camera not complying with USB PD can receive, via the DC coupler, power supplied from a power supply apparatus complying with USB PD.

The USB PD standard defines the maximum current value of supply power to 3 A or 5 A. Therefore, to receive a large amount of power, the supply voltage of the power supply apparatus needs to be increased. However, if the maximum value of the voltage (allowable voltage) that can be received by the digital camera is lower than the voltage supplied to the DC coupler from the power supply apparatus, the DC coupler needs to perform voltage conversion into the allowable voltage, and a power loss occurs through the voltage conversion.

In view of the background, Japanese Patent Laid-Open No. 2021-064194 describes a method in which, when a power receiving apparatus is in a power saving state, it requests a supply voltage lower than in a normal state from a power supply apparatus, thereby performing power supply without voltage conversion.

According to Japanese Patent Laid-Open No. 2021-064194, when a power receiving apparatus is in a power saving state, power supply is performed without voltage conversion, so that a power loss can be reduced. However, the power saving state is a state with extremely low power consumption, and it is difficult to reduce a power loss in a normal state with high power consumption.

### SUMMARY

The present disclosure has been made in consideration of the aforementioned problems, and provides technical advantages of reducing a power loss through voltage conversion of a supply voltage.

In order to solve the aforementioned problems, the present disclosure is directed to an electronic apparatus comprising: a first connector; a second connector; and a processor that causes the apparatus to function as: a power receiving unit that receives power from a power supply apparatus connected to the first connector; a voltage conversion unit that converts a voltage supplied from the power supply apparatus via the first connector; and a control unit that performs control to switch, in accordance with information regarding power consumption of a power receiving apparatus which is acquired from the power receiving apparatus connected to the second connector, between a first state where a voltage supplied from the power supply apparatus is output to the power receiving apparatus via the second connector without conversion by the voltage conversion unit, and a second state where a voltage converted by the voltage conversion unit is output to the power receiving apparatus via the second connector, wherein, in a case where power consumption based on information regarding power consumption of the power receiving apparatus is not less than a threshold, the control unit performs control to cause the power supply apparatus to supply a first voltage, and switch to the second state, and in a case where the power consumption is less than the threshold, the control unit performs control to cause the power supply apparatus to supply a second voltage lower than the first voltage, and switch to the first state.

According to the present disclosure, an unnecessary power loss through voltage conversion of a supply voltage can be reduced.

Features of the present disclosure will become apparent from the following description of embodiments with reference to the attached drawings. The following description of embodiments is described by way of example.

### BRIEF DESCRIPTION OF THE DRAWINGS

The accompanying drawings, which are incorporated in and constitute a part of the specification, illustrate embodiments of the present disclosure, and together with the description, serve to explain the principles of the embodiments.

FIG. 1 is a view showing an example of connection among an electronic apparatus, a power supply apparatus, and a power receiving apparatus according to the present embodiment;

FIG. 2 is a block diagram illustrating the configuration of an electronic apparatus according to a first embodiment;

FIG. 3 is a block diagram illustrating the configuration of a power receiving apparatus according to the first embodiment;

FIG. 4 is a block diagram illustrating the configuration of a battery mounting unit of the power receiving apparatus according to the first embodiment;

FIG. 5 is a flowchart illustrating the control processing of the electronic apparatus according to the first embodiment;

FIG. 6 is a flowchart illustrating the control processing of the power receiving apparatus according to the first embodiment;

FIG. 7 is a block diagram illustrating the configuration of an electronic apparatus according to a second embodiment;

FIG. 8 is a block diagram illustrating the configuration of a power receiving apparatus according to the second embodiment;

FIG. 9 is a flowchart illustrating the control processing of the electronic apparatus according to the second embodiment;

FIG. 10 is a flowchart illustrating the control processing of the power receiving apparatus according to the second embodiment;

FIG. 11 is a block diagram illustrating the configuration of an electronic apparatus according to a third embodiment; and

FIG. 12 is a flowchart illustrating the control processing of the electronic apparatus according to the third embodiment.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

The present embodiment constitutes a system in which an electronic apparatus is attached to a power receiving apparatus, the electronic apparatus is connected to a power supply apparatus by a cable, and power is supplied from the power supply apparatus to the power receiving apparatus via the electronic apparatus. In the present embodiment, an example will be described in which the electronic apparatus controls the supply voltage from the power supply apparatus and whether to perform voltage conversion of the supply voltage in accordance with the power consumption of the power receiving apparatus, thereby reducing an unnecessary power loss through voltage conversion.

### First Embodiment

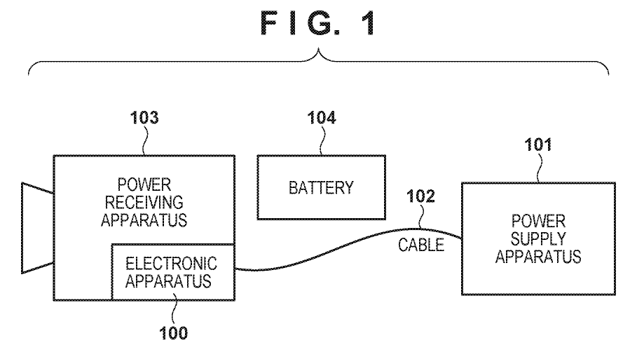

With reference to FIGS. 1-6, a first embodiment will be described below.

### System Configuration

First, with reference to FIG. 1, an example of connection among an electronic apparatus, a power supply apparatus, and a power receiving apparatus according to the present embodiment will be described.

FIG. 1 is a view showing an example of connection among an electronic apparatus, a power supply apparatus, and a power receiving apparatus according to the present embodiment.

A system according to the present embodiment includes an electronic apparatus 100, a power supply apparatus 101, and a power receiving apparatus 103.

When a battery 104 is attached to the power receiving apparatus 103, the power receiving apparatus 103 operates on power from the battery 104. Instead of the battery 104, the electronic apparatus 100 can be attached to the power receiving apparatus 103. The power supply apparatus 101 can be connected to the electronic apparatus 100, and supplies power to the electronic apparatus 100. The electronic apparatus 100 supplies the power received from the power supply apparatus 101 to the power receiving apparatus 103.

The power receiving apparatus 103 is, for example, a digital camera, a digital video camera, a smartphone, or a tablet computer.

The electronic apparatus 100 is, for example, a DC coupler. The power supply apparatus 101 is, for example, a power bank.

Each of the power supply apparatus 101 and the electronic apparatus 100 includes a connector complying with the USB Type-C standard, and they can be connected to each other by a USB Type-C cable 102. The power supply apparatus 101 and the electronic apparatus 100 can supply and receive power by a method complying with the Universal Serial Bus (USB) Power Delivery (PD) standard.

In the present embodiment, the power supply apparatus 101 operates as a source device complying with the USB PD standard, and supplies power to a sink device. The electronic apparatus 100 operates as a sink device complying with the USB PD standard, and receives power supplied from a source device. In the USB PD standard, by performing negotiation between a source device and a sink device, power of 240 W (48 V, 5 A) at maximum can be supplied from the source device to the sink device.

The electronic apparatus 100 supplies the power received from the power supply apparatus 101 to the power receiving apparatus 103. The power receiving apparatus 103 can operate on the power received from the electronic apparatus 100. The power receiving apparatus 103 includes a battery mounting unit, and can operate on the power from the battery 104. In the present embodiment, the battery 104 is, for example, a 2-cell lithium-ion battery.

When the electronic apparatus 100 is attached to the battery mounting unit instead of the battery 104, the power receiving apparatus 103 can operate on the power received from the electronic apparatus 100.

In the present embodiment, the power receiving apparatus 103 and the electronic apparatus 100 are individual apparatuses, but they may be configured as a single apparatus including the function of the power receiving apparatus 103 and the function of the electronic apparatus 100.

### Apparatus Configuration

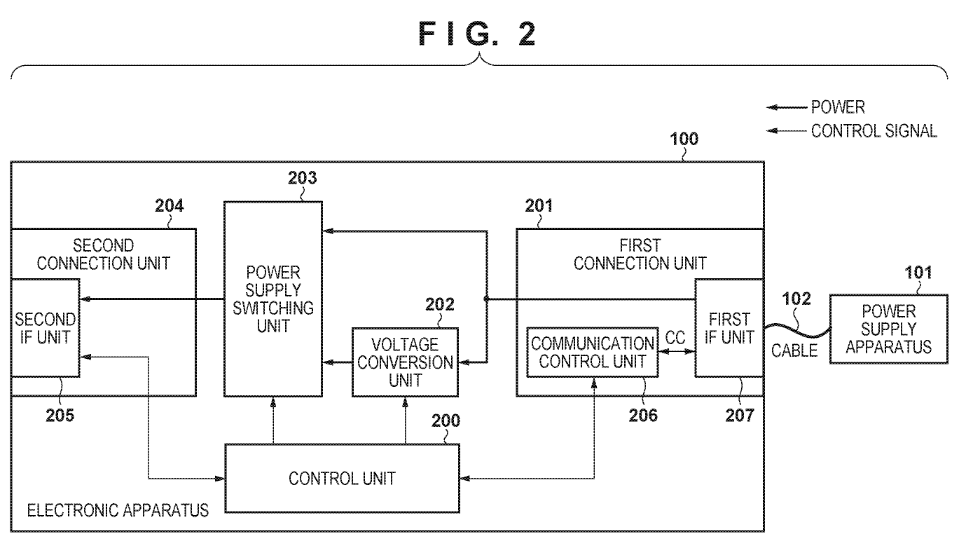

Next, with reference to FIGS. 2-4, the configuration and function of each of the electronic apparatus 100 and the power receiving apparatus 103 according to the first embodiment will be described.

FIG. 2 is a block diagram illustrating the configuration of the electronic apparatus 100 according to the first embodiment.

The electronic apparatus 100 includes a control unit 200, a first connection unit 201, a voltage conversion unit 202, a power supply switching unit 203, and a second connection unit 204.

The first connection unit 201 includes a first interface (IF) unit 207 and a communication control unit 206.

The first IF unit 207 is a connector complying with the USB Type-C standard, and connected to the power supply apparatus 101 via the USB Type-C cable 102.

The communication control unit 206 is connected to the CC (configuration channel) terminal of the first IF unit 207, and operates as a USB PD controller that performs communication (to be referred to as CC communication hereinafter) complying with the USB PD standard. By the CC communication, the communication control unit 206 detects the connection with the power supply apparatus 101 and a combination of the voltage and the current that can be supplied from the connected power supply apparatus 101, and notifies the detection result to the control unit 200.

Based on the control of the control unit 200, the communication control unit 206 performs power negotiation with the connected power supply apparatus 101 to request the voltage of the determined desired power from the power supply apparatus 101. The power supply apparatus 101 supplies the voltage of the requested power to the electronic apparatus 100, and the electronic apparatus 100 can receive the desired power. The communication control unit 206 performs control to output, to the voltage conversion unit 202, the voltage (to be referred to as the VBUS voltage hereinafter) input from the power supply apparatus 101 via the VBUS terminal of the first IF unit 207.

The communication control unit 206 performs power negotiation using Programmable Power Supply (PPS). PPS is a function added to the USB PD 3.0 standard. By using the PPS function, the voltage to be supplied from the source device can be set in 20 mV increments, and the current to be supplied from the source device can be set in 50 mA increments. In normal power negotiation, the USB PD standard restricts the power consumption of the sink device to 2 W or less when changing the voltage supplied from the source device. On the other hand, PPS does not restrict the power consumption associated with voltage change. When changing the supply voltage during power supply after power negotiation, the communication control unit 206 changes the voltage value in accordance with the PPS specification.

The voltage conversion unit 202 is a DC-DC converter that boosts or steps down the VBUS voltage input from the first connection unit 201, thereby converting it into a predetermined voltage. Under the control of the control unit 200, the voltage conversion unit 202 converts the VBUS voltage input from the first connection unit 201 into a voltage (to be referred to as an input allowable voltage hereinafter) that can be received by the power receiving apparatus 103, and outputs it to the power supply switching unit 203. In the present embodiment, the input allowable voltage of the power receiving apparatus 103 is 9 V, and the voltage conversion unit 202 converts the VBUS voltage input from the first connection unit 201 into 9 V. Note that the input allowable voltage of the power receiving apparatus 103 is not limited to 9 V, and can be set to an arbitrary voltage value.

The power supply switching unit 203 is a switch circuit that switches the path through which the VBUS voltage input from the first connection unit 201 is output to the second connection unit 204. Under the control of the control unit 200, the power supply switching unit 203 can switch between the first state and the second state. The first state is a state where the VBUS voltage input from the first connection unit 201 is output to the second connection unit 204 without voltage conversion by the voltage conversion unit 202. In the first state, since the voltage conversion unit 202 does not perform voltage conversion, a loss through voltage conversion by the voltage conversion unit 202 does not occur. The second state is a state where the VBUS voltage input from the first connection unit 201 is output to the second connection unit 204 after voltage conversion by the voltage conversion unit 202. In the second state, since the voltage conversion unit 202 performs voltage conversion, a loss through voltage conversion by the voltage conversion unit 202 occurs.

The second connection unit 204 includes a second IF unit 205.

When the electronic apparatus 100 is attached to the power receiving apparatus 103, the second IF unit 205 is connected to the power receiving apparatus 103. The power supply terminal of the second IF unit 205 is connected to the power supply switching unit 203. When the electronic apparatus 100 is attached to the power receiving apparatus 103, the second IF unit 205 supplies the power input from the power supply switching unit 203 to the power receiving apparatus 103. The communication terminal of the second IF unit 205 is connected to the control unit 200. When the electronic apparatus 100 is attached to the power receiving apparatus 103, the power receiving apparatus 103 and the control unit 200 communicate via the communication terminal of the second IF unit 205.

The control unit 200 includes a processor, a ROM storing a program to be executed by the processor, and a RAM where the program read out from the ROM and constants and variables for executing the program are loaded. The control unit 200 executes the program stored in the ROM, thereby controlling the respective components of the electronic apparatus 100.

The control unit 200 communicates with the power receiving apparatus 103 via the communication terminal of the second IF unit 205, and controls the respective components of the electronic apparatus 100 in accordance with the communication contents. The control unit 200 acquires information (power consumption information) indicating the power consumption of the power receiving apparatus 103, and controls the voltage conversion unit 202, the power supply switching unit 203, and the communication control unit 206 in accordance with the acquired power consumption information.

If the power consumption of the power receiving apparatus 103 is equal to or higher than a threshold, the control unit 200 controls the communication control unit 206 to set the voltage to be supplied from the power supply apparatus 101 to 15 V. The control unit 200 controls the voltage conversion unit 202 to convert the VBUS voltage of 15 V input via the first IF unit 207 into 9 V, and controls the power supply switching unit 203 to output the voltage from the voltage conversion unit 202 to the second IF unit 205.

If the power consumption of the power receiving apparatus 103 is lower than the threshold, the control unit 200 controls the communication control unit 206 to set the voltage to be supplied from the power supply apparatus 101 to 9 V. The control unit 200 controls the power supply switching unit 203 to output the VBUS voltage of 9 V, which is input from the first IF unit 207, to the second IF unit 205 without passing through the voltage conversion unit 202.

In the present embodiment, the threshold for the power consumption of the power receiving apparatus 103 is 25 W. The power supply apparatus 101 can supply any one of power of 15 W (5V, 3A), power of 27 W (9V, 3A), and power of 45 W (15V, 3A). If the electronic apparatus 100 requests the VBUS voltage of 9 V, the power supply apparatus 101 can supply power of up to 27 W (9 V × 3 A). If the electronic apparatus 100 requests the VBUS voltage of 15 V, the power supply apparatus 101 can supply power of up to 45 W (15 V × 3 A). The threshold is set to a threshold considering the power upon receiving 9 V from the power supply apparatus 101, a transmission loss in the USB Type-C cable 102, and a transmission loss in the electronic apparatus 100. Note that the threshold is not limited to 25 W and can be set arbitrarily. When the VBUS voltage of 15 V is supplied from the power supply apparatus 101, the voltage conversion unit 202 converts the VBUS voltage from 15 V into 9 V. On the other hand, the maximum value of the current output from the voltage conversion unit 202 is (3 × 15/9) A, which is 5 A. When the power supply switching unit 203 is controlled to output the voltage from the voltage conversion unit 202 to the second IF unit 205, power of up to 9 V × 5 A, which is 45 W, is supplied from the second IF unit 205.

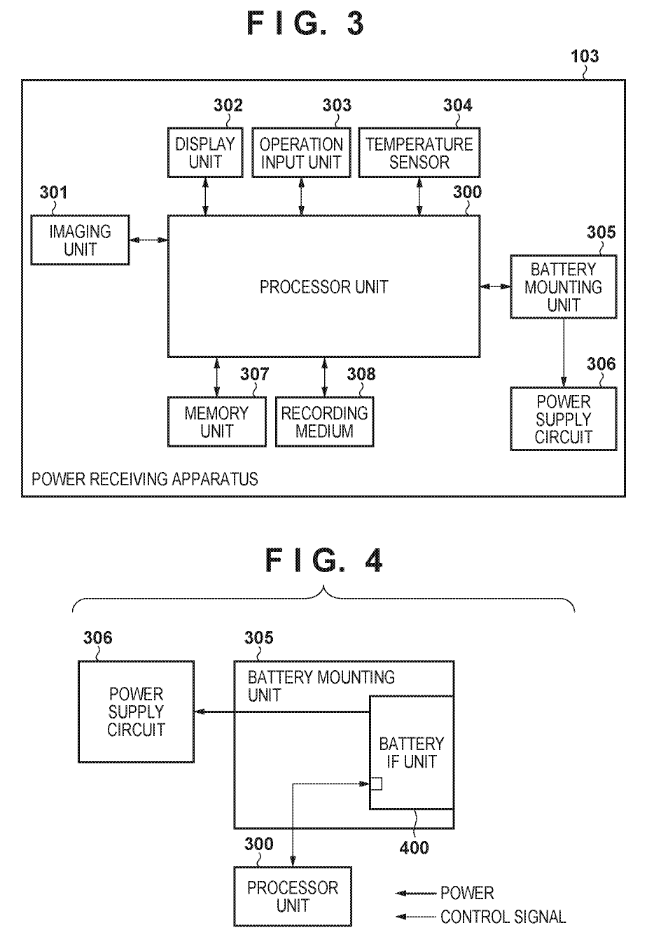

FIG. 3 is a block diagram illustrating the configuration of the power receiving apparatus 103 according to the first embodiment.

The power receiving apparatus 103 includes a processor unit 300, an imaging unit 301, a display unit 302, an operation input unit 303, a temperature sensor 304, a battery mounting unit 305, a power supply circuit 306, a memory unit 307, and a recording medium 308.

The processor unit 300 executes the program stored in the memory unit 307, thereby controlling various kinds of processing of input/output data and the respective components of the power receiving apparatus 103.

In the imaging unit 301, a lens unit (not shown) forms the optical image of an object on the imaging surface of an image sensor (not shown), and an image signal is generated from the optical image formed on the imaging surface. The image signal generated by the imaging unit 301 undergoes image processing and predetermined processing such as encoding processing by the processor unit 300, and is displayed on the display unit 302 or recorded in the recording medium 308 as image data.

Under the control of the processor unit 300, the display unit 302 displays image data for checking the object during shooting. The display unit 302 also displays the reproduction of image data recorded in the recording medium 308, and various kinds of setting information of the power receiving apparatus 103.

The operation input unit 303 is a user interface for the user operating the power receiving apparatus 103. Based on the operation input to the operation input unit 303, the processor unit 300 performs various kinds of processing.

The temperature sensor 304 detects the temperature of each component of the power receiving apparatus 103. The processor unit 300 acquires, as temperature information, the temperature detected by the temperature sensor 304, and performs various kinds of processing. For example, based on the difference between the detected temperature and the maximum operating temperature stored in the memory unit 307 in advance, the processor unit 300 determines whether to stop the operation due to temperature rise, and stops the operation of the power receiving apparatus 103 if it reaches the maximum operating temperature.

When the battery 104 is attached, the battery mounting unit 305 outputs the power received from the battery 104 to the power supply circuit 306. The battery mounting unit 305 is also connected to the processor unit 300, and communicates with the attached battery 104 under the control of the processor unit 300. Note that the electronic apparatus 100 can be attached to the battery mounting unit 305 instead of the battery 104. The details of the configuration of the battery mounting unit 305 will be described later.

The memory unit 307 is a storage unit that stores a program to be executed by the processor unit 300, and various kinds of information used for various kinds of processing of the processor unit 300. In addition to the program, for example, reference data used in image processing, power consumption information for each operating mode of the power receiving apparatus 103, operating mode information, image data for notifying the user of the state of the power receiving apparatus 103, and the like are stored in the memory unit 307.

The recording medium 308 is a storage unit that records image data encoded by the processor unit 300, and uses a memory card, a hard disk drive (HDD), a solid-state drive (SSD), or the like.

The power supply circuit 306 is a power supply control unit that supplies power to the respective components of the power receiving apparatus 103. The power supply circuit 306 converts the voltage value input from the battery mounting unit 305 into the voltage value required by each component. The power supply circuit 306 includes a plurality of power supply circuits in accordance with the voltage values required by the respective components.

FIG. 4 is a block diagram illustrating the configuration of the battery mounting unit 305 of the power receiving apparatus 103 according to the first embodiment.

The battery mounting unit 305 includes a battery IF unit 400.

The battery IF unit 400 is connected to the battery or the electronic apparatus 100 attached to the battery mounting unit 305. The power supply terminal of the battery IF unit 400 is connected to the power supply circuit 306, and the power received by the battery IF unit 400 is output to the power supply circuit 306. The communication terminal of the battery IF unit 400 is connected to the processor unit 300. Under the control of the processor unit 300, the battery IF unit 400 communicates with the battery 104 or the electronic apparatus 100.

When the electronic apparatus 100 is attached to the battery mounting unit 305, the processor unit 300 outputs various kinds of information to the electronic apparatus 100 via the battery IF unit 400.

Note that the processor unit 300 according to the present embodiment has two operating modes including a standby mode and a normal mode.

When a power supply circuit (not shown) converts the power input from the battery IF unit 400 into the power supply voltage (for example, 3.3 V) required for the standby mode and supplies it as the power for the processor unit 300, the processor unit 300 is activated in the standby mode.

Detection of the user operation input to the operation input unit 303 can be executed even in the standby mode.

When the electronic apparatus 100 connected to the power supply apparatus 101 is attached to the battery mounting unit 305, the VBUS voltage (5 V) is supplied from the electronic apparatus 100 before power negotiation between the electronic apparatus 100 and the power supply apparatus 101 and is converted into the power supply voltage required for the standby mode by the power supply circuit. The converted voltage is supplied to the processor unit 300, then the processor unit 300 is activated in the standby mode.

When the output of the power supply circuit 306 is input as the power supply of each component of the power receiving apparatus 103, the processor unit 300 is switched to the normal mode.

In the present embodiment, the processor unit 300 detects a user operation input to the operation input unit 303. However, another processor may be configured to perform power supply control and detect a user operation input.

### Control Processing

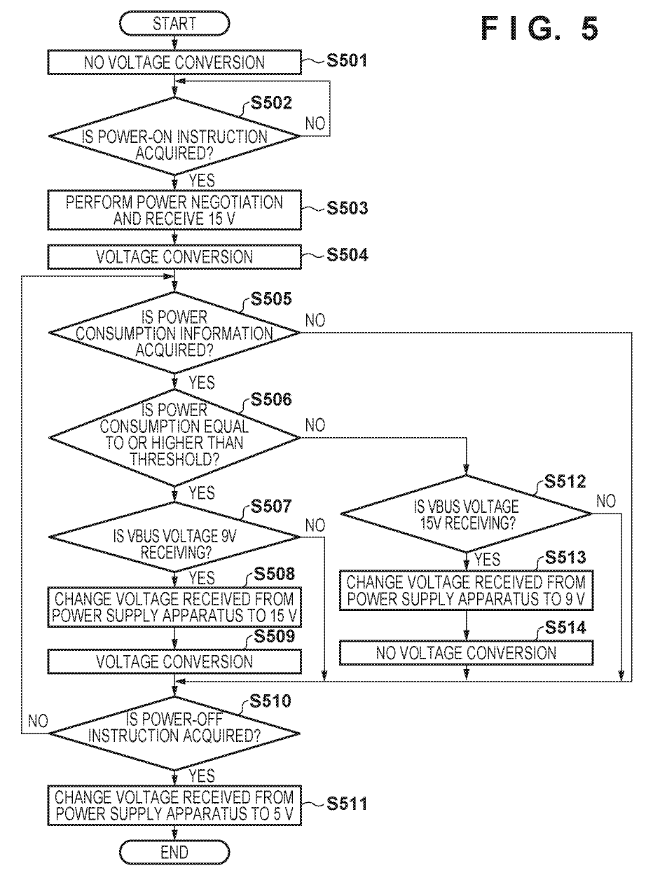

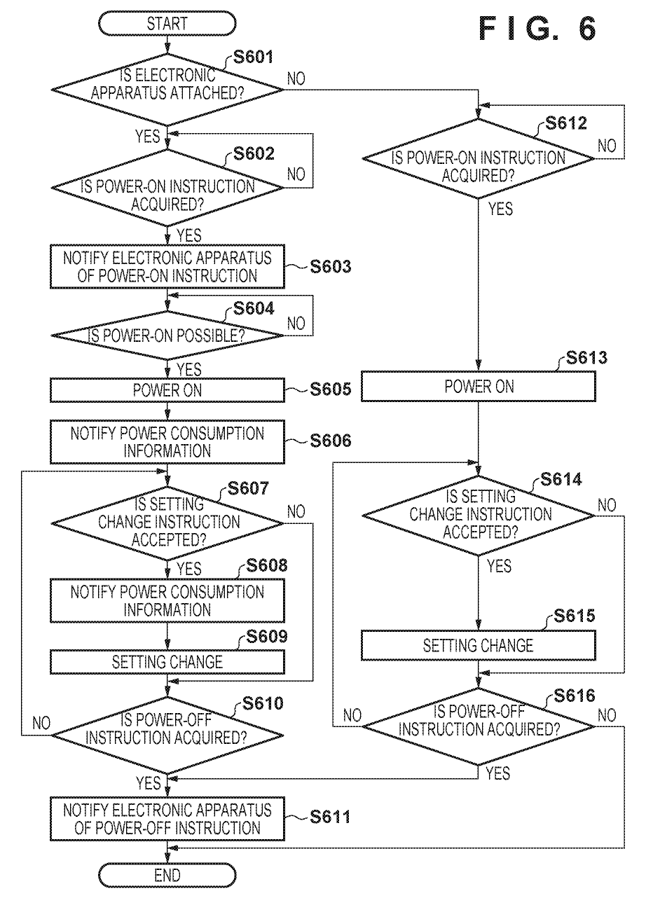

Next, with reference to FIG. 5, the control processing of the electronic apparatus 100 according to the first embodiment will be described.

FIG. 5 is a flowchart illustrating the control processing of the electronic apparatus 100 according to the first embodiment.

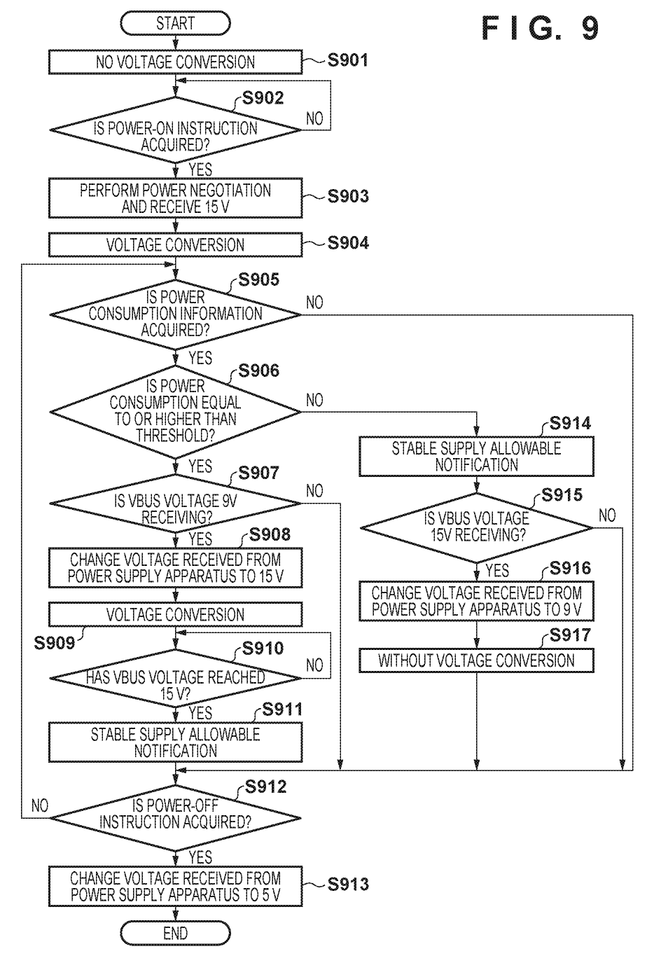

The processing illustrated in FIG. 5 is implemented when the control unit 200 executes the program stored in the ROM and controls the respective components of the electronic apparatus 100. This also applies to FIGS. 9 and 12 to be described later.

When the power supply apparatus 101 is connected to the electronic apparatus 100, 5 V, which is the VBUS voltage before power negotiation, is supplied from the power supply apparatus 101 to the first connection unit 201. This VBUS voltage is supplied to a power supply circuit (not shown), and the power supply circuit supplies power to the control unit 200. Thus, the processing illustrated in FIG. 5 is started.

In step S501, the control unit 200 controls the power supply switching unit 203 to output the VBUS voltage, which is input from the first connection unit 201, to the second connection unit 204 without passing through the voltage conversion unit 202. If the power receiving apparatus 103 is connected to the electronic apparatus 100, the voltage of 5 V, which is the predetermined voltage, is supplied from the power supply switching unit 203 to the power receiving apparatus 103 via the second connection unit 204. When power is supplied to the power receiving apparatus 103 via the second connection unit 204, power is supplied to the power supply circuit 306 via the battery mounting unit 305 of the power receiving apparatus 103.

In step S502, the control unit 200 determines whether information instructing power-on is acquired from the power receiving apparatus 103 after starting power supply to the power receiving apparatus 103. The control unit 200 continues the processing until it determines that information instructing power-on is acquired from the power receiving apparatus 103. When it is determined that information instructing power-on is acquired from the power receiving apparatus 103, the control unit 200 advances the processing to step S503.

In step S503, the control unit 200 controls the communication control unit 206 to perform power negotiation with the power supply apparatus 101. Here, the control unit 200 controls the communication control unit 206 to request the voltage of 15 V from the power supply apparatus 101 by power negotiation. With the power negotiation, the voltage of 15 V is supplied from the power supply apparatus 101, and the first connection unit 201 receives 15 V as the VBUS voltage.

In step S504, the control unit 200 controls the voltage conversion unit 202 to convert the VBUS voltage of 15 V input from the first connection unit 201 into 9 V, and controls the power supply switching unit 203 to output the voltage from the voltage conversion unit 202 to the second connection unit 204.

In step S505, the control unit 200 determines whether power consumption information is acquired from the power receiving apparatus 103. When it is determined that power consumption information is acquired from the power receiving apparatus 103, the control unit 200 advances the processing to step S506. When it is not determined that power consumption information is acquired from the power receiving apparatus 103, the control unit 200 advances the processing to step S510.

In step S506, the control unit 200 compares the power consumption based on the power consumption information acquired in step S505 with a threshold, and determines whether the power consumption of the power receiving apparatus 103 is equal to or higher than the threshold. When it is determined that the power consumption of the power receiving apparatus 103 is equal to or higher than the threshold, the control unit 200 advances the processing to step S507. When it is determined that the power consumption of the power receiving apparatus 103 is lower than the threshold, the control unit 200 advances the processing to step S512.

In step S507, the control unit 200 determines whether the VBUS voltage from the power supply apparatus 101 is 9 V (whether 9 V is received). When it is determined that the VBUS voltage of 9 V is received from the power supply apparatus 101, the control unit 200 advances the processing to step S508. When it is determined that the VBUS voltage from the power supply apparatus 101 is not 9 V but 15 V, the control unit 200 advances the processing to step S510.

In step S508, the control unit 200 controls the communication control unit 206 to change the voltage to be received from the power supply apparatus 101 to 15 V. The communication control unit 206 performs power negotiation with the power supply apparatus 101 to request the power supply apparatus 101 to supply the voltage of 15 V. In response to the voltage request from the communication control unit 206, the power supply apparatus 101 changes the supply voltage from 9 V to 15 V and supplies it to the electronic apparatus 100.

In step S509, the control unit 200 controls the voltage conversion unit 202 to convert the VBUS voltage of 15 V input from the first connection unit 201 into 9 V, and controls the power supply switching unit 203 to output the voltage from the voltage conversion unit 202 to the second connection unit 204.

In step S510, the control unit 200 determines whether information instructing power-off is acquired from the power receiving apparatus 103. When information instructing power-off is not acquired from the power receiving apparatus 103, the control unit 200 returns the processing to step S505. When it is determined that information instructing power-off is acquired from the power receiving apparatus 103, the control unit 200 advances the processing to step S511.

In step S511, the control unit 200 controls the communication control unit 206 to change the voltage to be supplied from the power supply apparatus 101 to5 V. The communication control unit 206 performs power negotiation with the power supply apparatus 101 to request the power supply apparatus 101 to supply the voltage of 5 V. In response to the voltage request from the communication control unit 206, the power supply apparatus 101 changes the supply voltage to 5 V and supplies it to the electronic apparatus 100.

In step S512, the control unit 200 determines whether the VBUS voltage from the power supply apparatus 101 is 15 V (whether 15 V is received). When it is determined that the VBUS voltage from the power supply apparatus 101 is 15 V, the control unit 200 advances the processing to step S513. When the VBUS voltage from the power supply apparatus 101 is not 15 V but 9V, the control unit 200 advances the processing to step S510.

In step S513, the control unit 200 controls the communication control unit 206 to change the voltage to be received from the power supply apparatus 101 to 9 V. The communication control unit 206 performs power negotiation with the power supply apparatus 101 to request the power supply apparatus 101 to supply the voltage of 9 V. In response to the voltage request from the communication control unit 206, the power supply apparatus 101 changes the supply voltage from 15 V to 9 V and supplies it to the electronic apparatus 100.

In step S514, the control unit 200 controls the power supply switching unit 203 to output the VBUS voltage, which is input from the first connection unit 201, to the second connection unit 204 without passing through the voltage conversion unit 202.

Next, with reference to FIG. 6, the control processing of the power receiving apparatus 103 according to the first embodiment will be described.

FIG. 6 is a flowchart illustrating the control processing of the power receiving apparatus 103 according to the first embodiment.

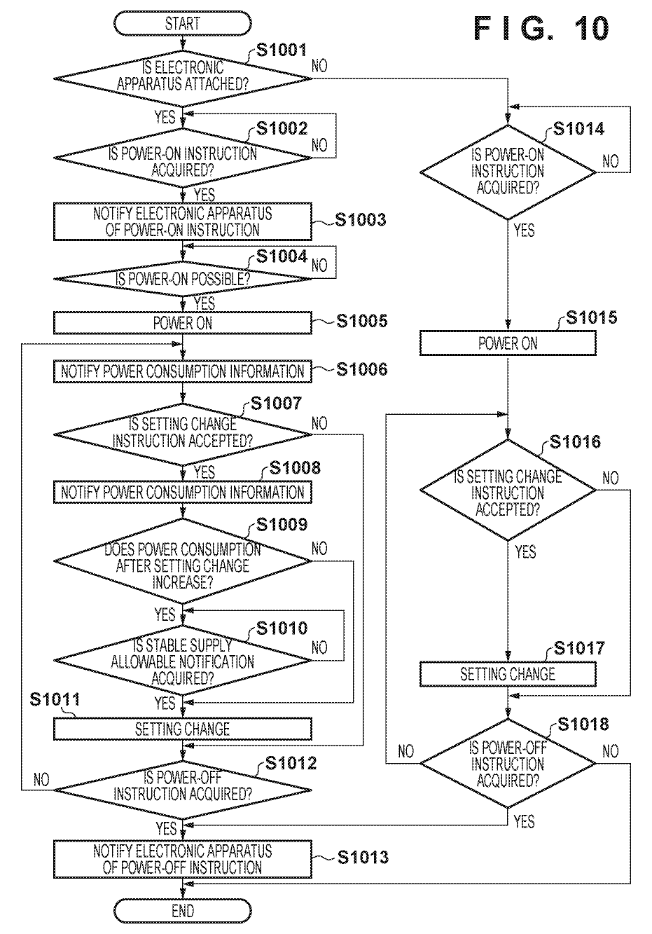

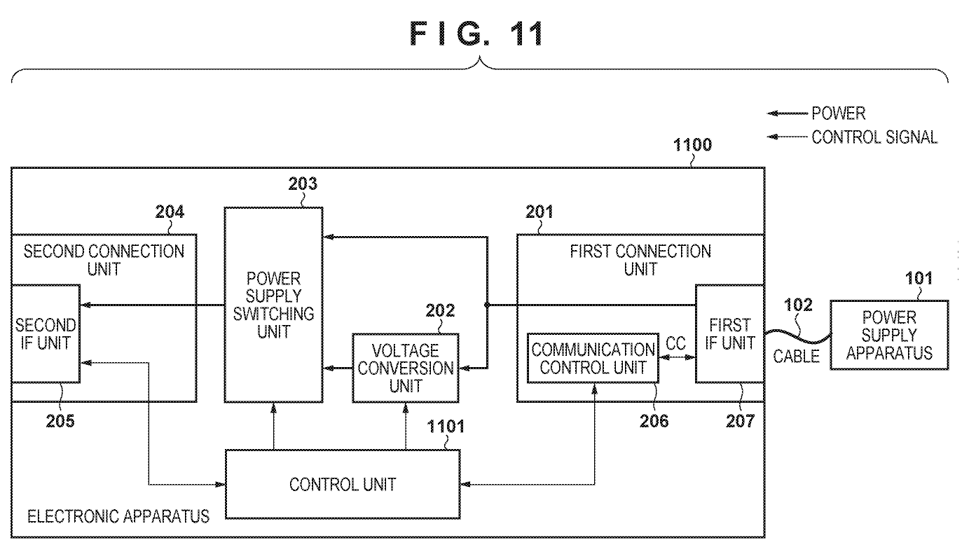

The processing illustrated in FIG. 6 is implemented when the processor unit 300 executes the program stored in the memory unit 307 and controls the respective components of the power receiving apparatus 103. This also applies to FIG. 10 to be described later.

As described above, when the battery 104 or the electronic apparatus 100 is connected to the battery mounting unit 305, the processor unit 300 is activated in the standby mode. When activated in the standby mode, the processor unit 300 executes the determined processing necessary upon activation. In addition, the processor unit 300 performs predetermined communication with the battery 104 or the electronic apparatus 100 via the battery mounting unit 305 to perform necessary processing. For example, the processor unit 300 communicates with the battery 104 or the electronic apparatus 100 to perform processing of determining the type of the battery 104 or the electronic apparatus 100, authentication processing of determining whether the battery 104 or the electronic apparatus 100 is an authenticated apparatus, and the like.

In step S601, the processor unit 300 determines whether the electronic apparatus 100 is attached to the battery mounting unit 305. When it is determined that the electronic apparatus 100 is attached to the battery mounting unit 305, the processor unit 300 advances the processing to step S602. When it is determined that not the electronic apparatus 100 but the battery 104 is attached to the battery mounting unit 305, the processor unit 300 advances the processing to step S612.

In step S602, the processor unit 300 determines whether the operation input unit 303 accepts a user operation instructing to power on the power receiving apparatus 103. The processor unit 300 continues the processing until it is determined that a user operation instructing to power on the power receiving apparatus 103 is accepted, and when it is determined that a user operation instructing power-on of the power receiving apparatus 103 is accepted, the processor unit 300 advances the processing to step S603.

In step S603, the processor unit 300 notifies the power supply circuit 306 of information instructing power-on via the communication terminal of the battery IF unit 400.

In step S604, the processor unit 300 determines whether it is possible to power on the power receiving apparatus 103. The processor unit 300 determines whether the output of the power supply circuit 306 is input as the power supply of each component of the power receiving apparatus 103. In this case, the processor unit 300 may acquire information indicating the completion of output from the power supply circuit 306 to make the determination. Alternatively, a detection circuit (not shown) that detects the power supplies of the respective components may be provided, and the processor unit 300 may acquire information from the detection circuit to make the determination.

The processor unit 300 continues the processing until it is determined that the output of the power supply circuit 306 is input as the power supply of each component of the power receiving apparatus 103, and when it is determined that the output of the power supply circuit 306 is input to each component of the power receiving apparatus 103, the processor unit 300 determines that the power receiving apparatus 103 can be powered on, and advances the processing to step S605.

In step S605, the processor unit 300 performs processing for setting the power receiving apparatus 103 in a power-on state. For example, the processor unit 300 sets the power receiving apparatus 103 in a shooting standby state.

In step S606, the processor unit 300 calculates the current power consumption of the power receiving apparatus 103, and notifies the power supply circuit 306 of power consumption information via the communication terminal of the battery IF unit 400.

In step S607, the processor unit 300 determines whether a user operation for changing the setting of the power receiving apparatus 103 is accepted via the operation input unit 303. When it is determined that a user operation for changing the setting is accepted, the processor unit 300 advances the processing to step S608. When a user operation for changing the setting is not accepted, the processor unit 300 advances the processing to step S610.

In step S608, the processor unit 300 calculates the predicted increase or decrease in power consumption caused by the setting change instructed by the user operation input in step S607. The processor unit 300 notifies, via the communication terminal of the battery IF unit 400, the power supply circuit 306 of the predicted power consumption after the operation setting change as power consumption information.

In step S609, the processor unit 300 changes the operation setting of the power receiving apparatus 103 in accordance with the user operation for changing the setting of the power receiving apparatus 103, which has been input via the operation input unit 303.

In step S610, the processor unit 300 determines whether a user operation instructing to power off the power receiving apparatus 103 is accepted via the operation input unit 303. When it is not determined that an instruction to power off the power receiving apparatus 103 is made, the processor unit 300 returns the processing to step S607. When it is determined that an instruction to power off the power receiving apparatus 103 is made, the processor unit 300 advances the processing to step S611.

In step S611, the processor unit 300 notifies the electronic apparatus 100 of information instructing power-off via the communication terminal of the battery IF unit 400, and transitions the power receiving apparatus 103 to a power-off state. Then, the processor unit 300 transitions to the standby mode and ends the processing.

In step S612, the processor unit 300 determines whether the operation input unit 303 accepts a user instruction instructing to power on the power receiving apparatus 103. The processor unit 300 continues the processing until it is determined that a user operation instructing to power on the power receiving apparatus 103 is accepted. When it is determined that a user operation instructing to power on the power receiving apparatus 103 is accepted, the processor unit 300 advances the processing to step S613.

In step S613, the processor unit 300 performs processing for setting the power receiving apparatus 103 in a power-on state. For example, the processor unit 300 sets the power receiving apparatus 103 in a shooting standby state.

In step S614, the processor unit 300 determines whether a user operation for changing the setting of the power receiving apparatus 103 is accepted via the operation input unit 303. When it is determined that a user operation for changing the setting is accepted, the processor unit 300 advances the processing to step S615. When a user operation for changing the setting is not accepted, the processor unit 300 advances the processing to step S616.

In step S615, the processor unit 300 changes the operation setting of the power receiving apparatus 103 in accordance with the user operation for changing the setting of the power receiving apparatus 103, which has been input via the operation input unit 303.

In step S616, the processor unit 300 determines whether a user operation instructing to power off the power receiving apparatus 103 is accepted via the operation input unit 303. When it is not determined that an instruction to power off the power receiving apparatus 103 is made, the processor unit 300 returns the processing to step S614. When it is determined that an instruction to power off the power receiving apparatus 103 is made, the processor unit 300 transitions to the standby mode and ends the processing.

According to the first embodiment described above, in accordance with the power consumption information of the power receiving apparatus 103, the supply voltage of the power supply apparatus 101 and whether to perform voltage conversion are controlled. Thus, an unnecessary power loss through voltage conversion can be reduced.

More specifically, if the power consumption of the power receiving apparatus is lower than the threshold, the electronic apparatus 100 requests 9 V from the power supply apparatus 101. Then, the VBUS voltage of 9 V from the power supply apparatus 101 is output to the power receiving apparatus 103 without conversion. Therefore, when the power consumption of the power receiving apparatus 103 is low, a power loss through voltage conversion in the electronic apparatus 100 does not occur.

Note that in the present embodiment, the power receiving apparatus 103 can operate on a 2-cell lithium-ion battery, but the number of cells is not limited to two and may be an arbitrary number. For example, when the power receiving apparatus 103 can operate on a 4-cell lithium-ion battery, the VBUS voltage of 15 V requires no voltage conversion, and voltage conversion is performed if the VBUS voltage is higher than 15 V. This is set in accordance with the maximum power consumption of the power receiving apparatus 103.

### Second Embodiment

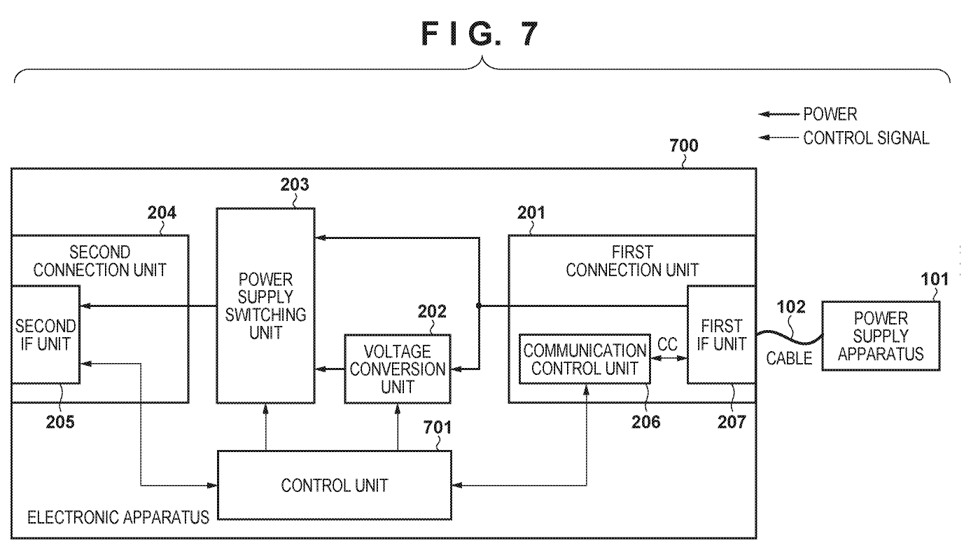

Next, with reference to FIGS. 7-10, a second embodiment will be described.

In the first embodiment, power negotiation using PPS is performed to cope with the voltage change during power supply. The USB PD standard defines only the maximum slew rate upon voltage change in PPS.

The slew rate upon voltage change may change depending on the power supply apparatus 101. Depending on the power supply apparatus 101, it may take a long time to change the voltage. If the power consumption of the power receiving apparatus increases after the electronic apparatus requests the changed voltage from the power supply apparatus and before the power supply apparatus actually supplies the changed voltage, a power shortage occurs.

For example, in a case where the VBUS voltage of 9 V is received and the power consumption is predicted to increase to 35 W due to the operation setting change of the power receiving apparatus 103, the VBUS voltage to be received needs to be changed to 15 V.

In this case, depending on the power supply apparatus 101, it may take a long time to change the voltage from 9 V to 15 V. If the operation state of the power receiving apparatus 103 is changed to an operation state with high power consumption during changing the supply voltage from the power supply apparatus, a power shortage occurs and the power receiving apparatus 103 may be shut down.

To prevent this, in the second embodiment, if the power consumption is predicted to increase due to the operation setting change of a power receiving apparatus 800, the power receiving apparatus 800 changes the operation setting based on a notification from an electronic apparatus 700. This prevents a shortage of supply power even when a power supply apparatus 101 takes a long time to change the voltage.

### Apparatus Configuration

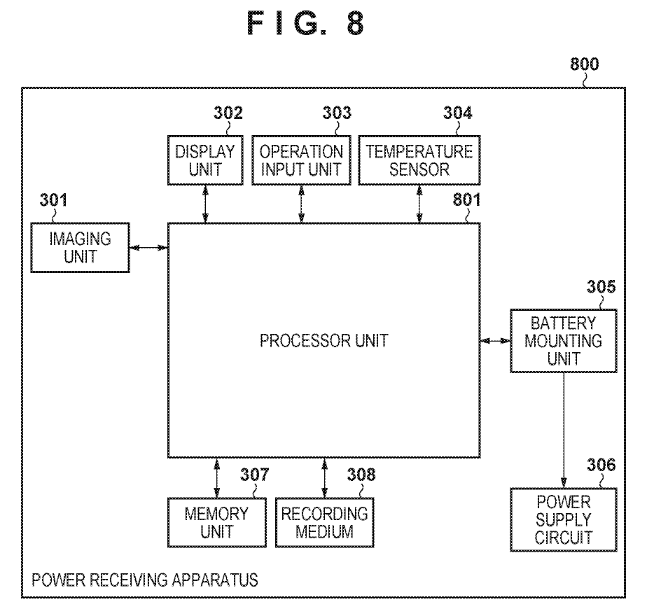

First, with reference to FIGS. 7 and 8, the configuration and function of each of the electronic apparatus 700 and the power receiving apparatus 800 according to the second embodiment will be described.

Note that a component having the same configuration and function as those in the first embodiment is denoted by the same reference numeral, and a description thereof will be omitted.

A control unit 701 controls a communication control unit 206 to request the power supply apparatus 101 to change the VBUS voltage. Then, the control unit 701 detects that changing the VBUS voltage from the power supply apparatus 101 is completed, that is, the voltage value has been changed. The control unit 701 uses power consumption information acquired from the power receiving apparatus 800 and the detection result upon changing the VBUS voltage to notify the power receiving apparatus 800 that the operation setting can be changed, that is, the power consumption can be changed.

A processor unit 801 acquires the notification from the electronic apparatus 700 via the communication terminal of a battery IF unit 400. If a user operation for changing the operation setting of the power receiving apparatus 800 is accepted via an operation input unit 303, the processor unit 801 changes the operation setting in accordance with acquisition of the notification from the electronic apparatus 700 indicating that the power consumption can be changed.

### Control Processing

Next, with reference to FIG. 9, the control processing of the electronic apparatus 700 according to the second embodiment will be described.

FIG. 9 is a flowchart illustrating the control processing of the electronic apparatus 700 according to the second embodiment.

Steps S901 to S909, S912, S913, and S915 to S917 of FIG. 9 are similar to the processing in steps S501 to S514 of FIG. 5.

In step S908, the control unit 701 controls the communication control unit 206 to change the voltage to be received from the power supply apparatus 101 to 15 V. The communication control unit 206 performs power negotiation with the power supply apparatus 101 to request the power supply apparatus 101 to supply the voltage of 15V. In response to the voltage request from the communication control unit 206, the power supply apparatus 101 changes the supply voltage from 9 V to 15 V and supplies it to the electronic apparatus 700.

In step S909, the control unit 701 controls a power supply switching unit 203 to output the voltage from a voltage conversion unit 202 to a second connection unit 204.

In step S910, the control unit 701 determines whether the VBUS voltage has reached 15 V. The control unit 701 continues the processing until the VBUS voltage reaches 15 V. When it is determined that the VBUS voltage has reached 15 V, the control unit 701 advances the processing to step S911.

In step S911, the control unit 701 issues, to the power receiving apparatus 800, a notification (stable supply allowable notification) indicating that the operation setting can be changed, that is, the power consumption can be changed.

When it is determined that the power consumption of the power receiving apparatus 800 is lower than a threshold in step S906, the control unit 701 advances to step S914 and issues, to the power receiving apparatus 800, a stable supply allowable notification indicating that the operation setting can be changed, that is, the power consumption can be changed.

Next, with reference to FIG. 10, the control processing of the power receiving apparatus 800 according to the second embodiment will be described. FIG. 10 is a flowchart illustrating the control processing of the power receiving apparatus 800 according to the second embodiment.

Steps S1001 to S1008 and S1011 to S1018 of FIG. 10 are similar to the processing in steps S601 to S616 of FIG. 6.

In step S1008, based on the state of the power receiving apparatus 800 set by the user in step S1007, the processor unit 801 performs processing of predicting the power consumption of the power receiving apparatus 800 after the operation setting change. Then, the processor unit 801 notifies, via the communication terminal of the battery IF unit 400, the electronic apparatus 700 of information indicating the predicted power consumption as power consumption information.

In step S1009, the processor unit 801 determines whether the power consumption after the operation setting change, which is predicted in step S1008, increases compared to the current power consumption of the power receiving apparatus 800. When it is determined that the power consumption of the power receiving apparatus 800 after the operation setting change increases, the processor unit 801 advances the processing to step S1010. When it is determined that the power consumption of the power receiving apparatus 800 after the operation setting change does not increase, the processor unit 801 advances the processing to step S1011.

In step S1010, the processor unit 801 determines whether a stable supply allowable notification is acquired from the electronic apparatus 700. Until it is determined that a stable supply allowable notification is acquired from the electronic apparatus 700, the processor unit 801 waits without changing the operation setting of the power receiving apparatus 800. When it is determined that a stable supply allowable notification is acquired from the electronic apparatus 700, the processor unit 801 advances the processing to step S1011.

For example, if the current power consumption of the power receiving apparatus 800 is lower than the threshold in step S906, the VBUS voltage received from the power supply apparatus 101 by the electronic apparatus 700 is set to 9 V through the processing in steps S914 to S917, as described above. Therefore, if the power consumption after the setting change increases but remains lower than the threshold in step S906, the processing for changing the VBUS voltage is not performed in the electronic apparatus 700, and the electronic apparatus 700 transmits a stable supply allowable notification in step S914. Hence, after the user instructs to change the setting of the power receiving apparatus 800, the setting can be changed immediately. When it is determined that the power consumption does not increase in step S1009 of FIG. 10, the setting is changed without waiting for a stable supply allowable notification. For example, in a case where the power receiving apparatus 800 is switched from a state where the voltage of 15 V from the electronic apparatus 700 is required to a state where 9 V is sufficient, the processor unit 801 changes the setting of the power receiving apparatus 800 without waiting for a stable supply allowable notification. If the current power consumption of the power receiving apparatus 800 is equal to or higher than the threshold in step S906, the voltage received from the power supply apparatus 101 by the electronic apparatus 700 is set to 15 V through the processing in steps S907 to S911, as described above. Hence, even if the power consumption of the power receiving apparatus 800 after the setting change does not increase but remains equal to or higher than the threshold in step S906, the necessary power for the power receiving apparatus 800 after the setting change is supplied from the electronic apparatus 700. Accordingly, the processor unit 801 changes the setting of the power receiving apparatus 800 without waiting for a stable supply allowable notification.

According to the second embodiment described above, when changing the operation setting of the power receiving apparatus 800 that increases power consumption, the operation setting is changed after a stable supply allowable notification is acquired from the electronic apparatus 700. Even when the power supply apparatus 101 that takes a long time to change the voltage is connected, the power receiving apparatus 800 can be prevented from being shut down due to a shortage of supply power.

### Third Embodiment

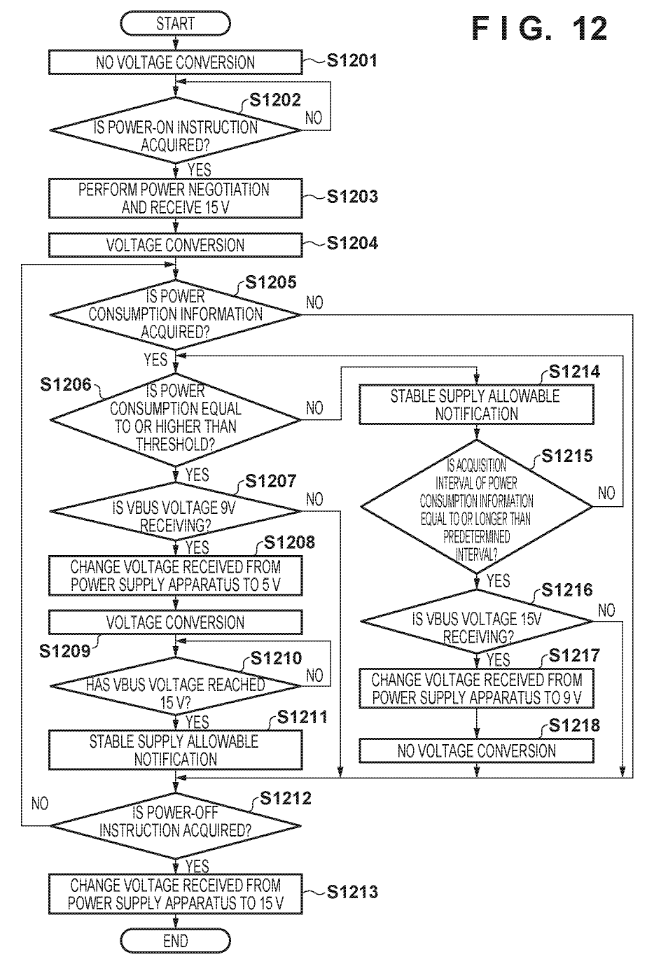

With reference to FIGS. 11 and 12, the third embodiment will be described.

In the second embodiment, if the power consumption is predicted to increase due to the operation setting change of the power receiving apparatus 800, the power receiving apparatus 800 changes the operation setting after a stable supply allowable notification is received from the electronic apparatus 700. Thus, a shortage of supply power from the power supply apparatus 101 is avoided.

This can prevent the power receiving apparatus 800 from being shut down due to a shortage of supply power. However, when the power supply apparatus 101 connected to the electronic apparatus 700 takes a long time to change the voltage, the time required to change the operation setting also becomes long.

In addition, when the user changes the operation setting of the power receiving apparatus 800, the user may select an unintended operation setting change due to an operation error or the like, and then notice the error and select the intended operation setting change.

Assume that, in accordance with the predicted power consumption based on the unintended operation setting change which is temporarily selected, the electronic apparatus 700 performs control to decrease the VBUS voltage of the power supply apparatus 101. For example, the electronic apparatus 700 performs control to change the VBUS voltage from 15 V to 9 V.

Thereafter, when the electronic apparatus 700 performs control to increase the VBUS voltage in accordance with the predicted power consumption based on the intended operation setting change, it needs a waiting time to wait until the VBUS voltage reaches the predetermined voltage, so that the time required to change the operation setting becomes long. Although caused by the user's operation error, this leads to an unnecessary waiting time when changing the operation setting.

To prevent this, in the third embodiment, by suppressing the control by an electronic apparatus 1100 for decreasing the VBUS voltage of an power supply apparatus 101 based on a user's operation error or the like, an unnecessary waiting time when changing the operation setting is reduced.

### Apparatus Configuration

First, with reference to FIG. 11, the configuration and function of the electronic apparatus 1100 according to the third embodiment will be described.

Note that a component having the same configuration and function as those in the first or second embodiment is denoted by the same reference numeral, and a description thereof will be omitted.

The configuration of a power receiving apparatus is the same as in the first or second embodiment.

A control unit 1101 measures the time interval of acquiring power consumption information. The control unit 1101 calculates the acquisition interval from the acquisition time of the power consumption information acquired first and the acquisition time of the power consumption information acquired next. Based on the calculated acquisition interval, the control unit 1101 determines whether the next power consumption information is acquired within a predetermined period. In the present embodiment, the predetermined period used for determination by the control unit 1101 is 1 sec.

If the power consumption information is acquired from the power receiving apparatus within the predetermined period, the control unit 1101 determines that the power consumption information acquired first indicates the power consumption predicted in accordance with the operation setting change based on a user's operation error or the like. Note that in the present embodiment, the predetermined period used for determination by the control unit 1101 is 1 sec, but the predetermined period is not limited thereto and may be arbitrarily set.

### Control Processing

Next, with reference to FIG. 12, the control processing of the electronic apparatus 1100 according to the third embodiment will be described.

FIG. 12 is a flowchart illustrating the control processing of the electronic apparatus 1100 according to the third embodiment.

Steps S1201 to S1214 and S1216 to S1218 of FIG. 12 are similar to the processing in steps S901 to S917 of FIG. 9.

In step S1206, when the control unit 1101 determines that the power consumption based on the power consumption information acquired in step S1205 is lower than the threshold, the control unit 1101 advances the processing to step S1214.

In step S1214, the control unit 1101 issues, to a power receiving apparatus 800, a stable supply allowable notification indicating that the operation setting can be changed, that is, the power consumption can be changed.

In step S1215, the control unit 1101 determines whether the interval between acquisition of the preceding power consumption information from the power receiving apparatus 800 and acquisition of the current power consumption information from the power receiving apparatus 800 is equal to or longer than the predetermined interval. When the acquisition interval of the power consumption information from the power receiving apparatus 800 is shorter than the predetermined interval, the control unit 1101 returns the processing to step S1206. When it is determined that the acquisition interval is equal to or longer than the predetermined interval, the control unit 1101 advances the processing to step S1216.

According to the third embodiment described above, it is determined whether the interval between the times when the electronic apparatus 1100 acquires the power consumption information from the power receiving apparatus 800 is equal to or longer than the predetermined interval. When it is determined that the acquisition interval of power consumption information is shorter than the predetermined interval, the power consumption information acquired first is determined to indicate the power consumption predicted in accordance with the operation setting change based on a user's operation error or the like, and the control by the electronic apparatus 1100 for decreasing the VBUS voltage of the power supply apparatus 101 is suppressed. This can reduce an unnecessary waiting time when changing the operation setting.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2025-053748, filed Mar. 27, 2025 which is hereby incorporated by reference herein in its entirety.

What is claimed is:

1. An electronic apparatus comprising:
a first connector;
a second connector; and
a processor that causes the apparatus to function as:
a power receiving unit that receives power from a power supply apparatus connected to the first connector;
a voltage conversion unit that converts a voltage supplied from the power supply apparatus via the first connector; and
a control unit that performs control to switch, in accordance with information regarding power consumption of a power receiving apparatus which is acquired from the power receiving apparatus connected to the second connector, between a first state where a voltage supplied from the power supply apparatus is output to the power receiving apparatus via the second connector without conversion by the voltage conversion unit, and a second state where a voltage converted by the voltage conversion unit is output to the power receiving apparatus via the second connector,
wherein, in a case where power consumption based on information regarding power consumption of the power receiving apparatus is not less than a threshold, the control unit performs control to cause the power supply apparatus to supply a first voltage, and switch to the second state, and in a case where the power consumption is less than the threshold, the control unit performs control to cause the power supply apparatus to supply a second voltage lower than the first voltage, and switch to the first state.

2. The electronic apparatus according to claim 1, wherein
the voltage conversion unit converts the first voltage into the second voltage.

3. The electronic apparatus according to claim 2, wherein
in a case where power consumption based on information regarding power consumption of the power receiving apparatus is not less than a threshold, and the second voltage is received from the power supply apparatus, the control unit requests the power supply apparatus to supply the first voltage, and performs control to switch to the second state where the second voltage, which is converted by the voltage conversion unit from the first voltage supplied from the power supply apparatus in response to the request, is output to the power receiving apparatus via the second connector.

4. The electronic apparatus according to claim 3, wherein
after requesting the first voltage from the power supply apparatus, in response to a voltage supplied from the power supply apparatus reaching the first voltage, the control unit performs control to issue, to the power receiving apparatus, a predetermined notification indicating that power consumption of the power receiving apparatus can be changed.

5. The electronic apparatus according to claim 3, wherein
in a case where power consumption based on information regarding power consumption of the power receiving apparatus is less than the threshold, the control unit transmits, to the power receiving apparatus, a predetermined notification indicating that stable power supply to the power receiving apparatus is possible, requests the second voltage from the power supply apparatus, and performs control to switch to the first state where the second voltage supplied from the power supply apparatus in response to the request is output to the power receiving apparatus via the second connector.

6. The electronic apparatus according to claim 2, wherein
in a case where power consumption based on information regarding power consumption of the power receiving apparatus is less than the threshold, and the first voltage is received from the power supply apparatus, the control unit requests the power supply apparatus to supply the second voltage, and performs control to switch to the first state where the second voltage supplied from the power supply apparatus in response to the request is output to the power receiving apparatus via the second connector.

7. The electronic apparatus according to claim 2, wherein
in a case where power consumption based on information regarding power consumption of the power receiving apparatus is less than the threshold, the control unit transmits, to the power receiving apparatus, a predetermined notification indicating that stable power supply to the power receiving apparatus is possible, requests the power supply apparatus to supply the second voltage, and performs control to switch to the first state where the second voltage supplied from the power supply apparatus in response to the request is output to the power receiving apparatus via the second connector.

8. The electronic apparatus according to claim 2, wherein
in a case where power consumption based on information regarding power consumption of the power receiving apparatus is less than the threshold, the control unit determines whether an acquisition interval of information regarding the power consumption from the power receiving apparatus is equal to or longer than a predetermined interval, and
in a case where it is determined that an acquisition interval of information regarding the power consumption is equal to or longer than a predetermined interval, and the first voltage is received from the power supply apparatus, the control unit requests the power supply apparatus to supply the second voltage, and performs control to switch to the first state where the second voltage supplied from the power supply apparatus in response to the request is output to the power receiving apparatus via the second connector, and in a case where it is determined that an acquisition interval of information regarding the power consumption is shorter than a predetermined interval, the control unit does not perform control for requesting the power supply apparatus to supply the second voltage and control for switching to the first state where the second voltage supplied from the power supply apparatus in response to the request is output to the power receiving apparatus via the second connector.

9. The electronic apparatus according to claim 1, wherein
in a case where the power supply apparatus is connected to the first connector and a predetermined voltage is supplied from the power supply apparatus, the control unit performs control to switch to the first state where the predetermined voltage is supplied to the power receiving apparatus via the second connector, and in a case where a power-on instruction is received from the power receiving apparatus, the control unit performs control to cause the power supply apparatus to supply a first voltage, and switch to the second state.

10. The electronic apparatus according to claim 1, wherein
the electronic apparatus and the power supply apparatus perform power transmission based on a Universal Serial Bus (USB) Power Delivery (PD) standard, and
the control unit performs power negotiation using Programmable Power Supply (PPS) of a USB PD standard to determine a voltage to request from the power supply apparatus.

11. The apparatus according to claim 1, wherein
the threshold is set to a value considering a power transmission loss in a case of receiving the second voltage from the power supply apparatus in the first state where the second voltage is supplied to the power receiving apparatus via the second connector.

12. A system including a power receiving apparatus and an electronic apparatus,
wherein
the power receiving apparatus includes
a mounting unit to which one of a battery and an electronic apparatus that supplies power to the power receiving apparatus is attached,
a first processor that changes an operation setting of the power receiving apparatus, and
wherein the first processor unit performs control to transmit, to the electronic apparatus, information regarding power consumption of the power receiving apparatus based on an operation setting set by the setting unit, in a case where the electronic apparatus is attached to the mounting unit,
the electronic apparatus includes
a first connector,
a second connector, and
a processor that causes the electronic apparatus to function as:
a power receiving unit that receives power from a power supply apparatus connected to the first connector;
a voltage conversion unit that converts a voltage supplied from the power supply apparatus via the first connector; and
a control unit that performs control to switch, in accordance with information regarding power consumption of a power receiving apparatus which is acquired from the power receiving apparatus connected to the second connector, between a first state where a voltage supplied from the power supply apparatus is output to the power receiving apparatus via the second connector without conversion by the voltage conversion unit, and a second state where a voltage converted by the voltage conversion unit is output to the power receiving apparatus via the second connector, and
in a case where power consumption based on information regarding power consumption of the power receiving apparatus is not less than a threshold, the control unit performs control to cause the power supply apparatus to supply a first voltage, and switch to the second state, and in a case where the power consumption is less than the threshold, the control unit performs control to cause the power supply apparatus to supply a second voltage lower than the first voltage, and switch to the first state.

13. A method of controlling an electronic apparatus:
wherein the electronic apparatus comprises:
a first connector;
a second connector; and
a processor that causes the electronic apparatus to function as:
a power receiving unit that receives power from a power supply apparatus connected to the first connector; and
a voltage conversion unit that converts a voltage supplied from the power supply apparatus via the first connector,
wherein the method comprises:
controlling to switch, in accordance with information regarding power consumption of a power receiving apparatus which is acquired from the power receiving apparatus connected to the second connector, between a first state where a voltage supplied from the power supply apparatus is output to the power receiving apparatus via the second connector without conversion by the voltage conversion unit, and a second state where a voltage converted by the voltage conversion unit is output to the power receiving apparatus via the second connector,
wherein the controlling to switch includes control for causing the power supply apparatus to supply a first voltage and switching to the second state in a case where power consumption based on information regarding power consumption of the power receiving apparatus is not less than a threshold, and control for causing the power supply apparatus to supply a second voltage lower than the first voltage and switching to the first state in a case where the power consumption is less than the threshold.
